(19) United States
(12) Patent Application Publication
(10) Pub. No.: US 2008/0125227 A1
(43) Pub. Date: May 29, 2008

(54) Online interactive real estate game

(75) Inventors: Ken Bui, San Jose, CA (US); Bhavinkumar Patel, San Jose, CA (US); Matt Dunlap, San Francisco, CA (US)

Correspondence Address: EVERGREEN VALLEY LAW GROUP, 2670 S. WHITE ROAD, SUITE 275, SAN JOSE, CA, 95148, US

(73) Assignee: Realivent Corporation, San Jose, CA (US)

(21) Appl. No.: 11/605,737

(22) Filed: Nov. 28, 2006

(51) Int. Cl. A63F 13/12

(52) U.S. Cl. 463/42

(57) ABSTRACT

A method and system for providing an online interactive real estate game allows individual players and teams of players to make guesses on any number of real estate variables, such as prices, trends, or characteristics of a property. In one embodiment, a server hosts the real estate game, and receives from a player/team a choice of a type of the real estate game to play. The player/team submits guesses for real estate variables for the chosen real estate game. Points are awarded based on the player or team's performance and activities. The guesses are collected and used to generate statistical reports on the real estate variables. The reports can then be distributed to third parties, such as an owner, seller, buyer or agent of the property. The collected guesses may further be used to refine a player's home search.

### BACKGROUND

1. Field

The present invention relates to online interactive games, and more particularly to online interactive games pertaining to real estate.

2. Related Art

Online interactive games are known in the art. Examples of such games include simulated sports games, gambling games, and stock market activity games. The existence of instantaneous communications technology allows people to participate in such fantasy games in real time. Players accumulate points based on performance and activity. However, there are no such games which pertain to real estate.

Accordingly, there exists a need for an online interactive real estate game. The invention described herein addresses such a need. The online interactive real estate game according to the invention allows players and teams of players to make guesses on any number of real estate variables, such as prices, trends, and characteristics, and earn points. In addition, the players' guesses and interaction with the game allows for the collection and aggregation of information on these variables, from which reports can be generated.

### SUMMARY

A method and system for providing an online interactive real estate game allows individual players and teams of players to make guesses on any number of real estate variables, such as prices, trends, or characteristics of a property. In one embodiment, a server hosts the real estate game, and receives from a player/team a choice of a type of the real estate game to play. The player/team submits guesses for real estate variables for the chosen real estate game. Points are awarded based on the player or team's performance and activities. The guesses are collected and used to generate statistical reports and/or pricing reports on the real estate variables. The reports can then be distributed to third parties, such as property owners, property sellers, home buyers and investors of properties. The collected guesses may further be used to refine a player's home search and/or determine a subjective price for a home.

### BRIEF DESCRIPTION OF DRAWINGS

FIG. 1 illustrates an embodiment of a system for providing an online interactive real estate game.

FIG. 2 is a flowchart illustrating an embodiment of the online interactive real estate game.

FIG. 3 is a flowchart illustrating the creation or maintenance of a team in the online interactive real estate game.

FIG. 4 illustrates contents of sample web pages for the online interactive real estate game.

FIG. 5 is a flowchart illustrating in more detail the playing of the real estate game.

FIG. 6 illustrates sample statistical reports that can be generated from the guesses collected through the online interactive real estate game.

FIG. 7 is a flowchart illustrating an embodiment of the pricing challenge.

FIG. 8 illustrates example pricing reports.

FIG. 9 is a flowchart illustrating an embodiment of the experts challenge.

FIG. 10 illustrates sample features reports.

FIG. 11 is a flowchart illustrating the use of a player's guesses in the online interactive real estate game to improve search results.

FIG. 12 is a flowchart illustrating an example points system in the online interactive real estate game.

### DETAILED DESCRIPTION

The online interactive real estate game according to the invention allows players and teams of players to make guesses on any number of real estate variables. Such variables include, but are not limited to, home prices, home trends, home characteristics, neighborhood prices, neighborhood trends, neighborhood characteristics, city trends, city characteristics, city prices, state prices, state trends, and state characteristics. An individual player or a team of player's performance and activity earns points. Aggregate points can be ranked and displayed on a leaderboard. The players' guesses and interaction with the game allows for the collection and aggregation of information on the real estate variables. This allows for the generation of statistical reports on the real estate variables. A player's guesses can further be used to refine the player's future search processes to increase efficiency. A player's guesses can also be used to provide an independent automated pricing valuation for the variables or home in play.

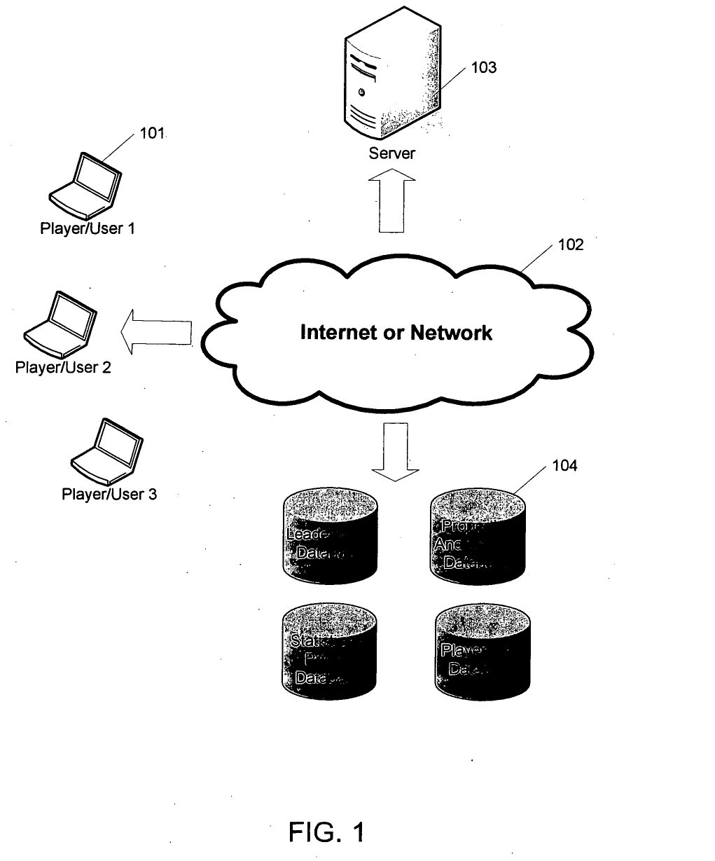

FIG. 1 illustrates an embodiment of a system for providing an online interactive real estate game. The system includes one or more players 101 who can connect via the Internet or a network 102 to a server 103 that is hosting the real estate game. In providing the real estate game, the server 103 uses at least a controller and memory (not shown) for executing programming code for the real estate game. The server 103 has access to one or more databases 104 that store data pertaining to the game. The databases 104 may store leaderboard data, properties and listings data, player data, and statistics and pricing data collected from the player's activities in the game.

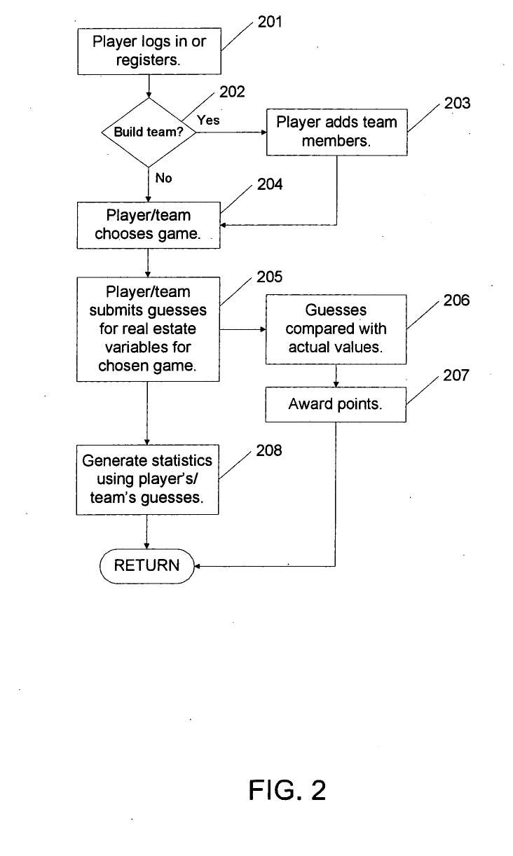

FIG. 2 is a flowchart illustrating an embodiment of the online interactive real estate game. First, a player logs in, or registers if the player is new, to play the real estate game (step 201). When the player registers, a player profile is created by the server 103 and stored in the player database. The player can then build a team (step 202) for play, or play as an individual. If the player decides to build a team, then the player adds team members (step 203). A team profile that includes information on the team members is created by the server 103 and stored. The player or team then chooses a specific real estate game to play (step 204). For example, the player or team can choose a particular real estate variable, such as the price or a feature of a property. Once the game is selected, the game begins. The player or team submits guesses for the real estate variable(s) relevant to the chosen game (step 205). The guesses are then compared with the actual values of the variable for a property (step 206). Points are awarded based on performance and/or activity (step 207). The player's or team's guesses are collected and used to generate statistics (step 208). Each of these steps is described in further detail below.

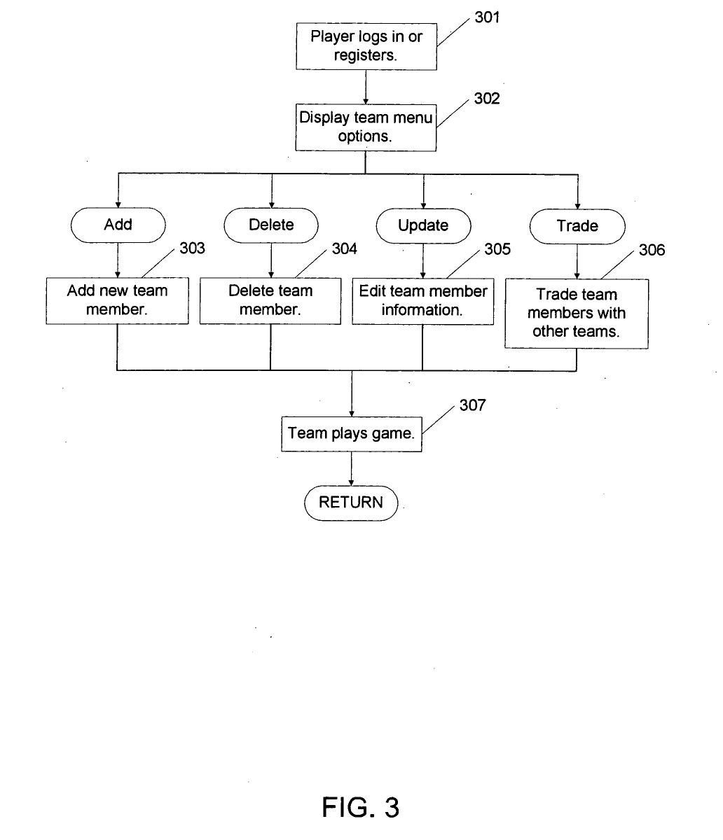

FIG. 3 is a flowchart illustrating the creation or maintenance of a team in the online interactive real estate game. After a player logs in or registers (step 301), a team menu is displayed (step 302). Example functions provided through the menu include “Add”, “Delete”, “Update”, and “Trade”. The player selects the “Add” function to add a new member to a team (step 303). The player selects the “Delete” function to remove one or more members from the team (step 304). The player selects the “Update” function to edit team member information (step 305), without changing the team membership. The player selects the “Trade” function to trade team members with other teams (step 306). Team members may be solicited by other teams for trade.

In one embodiment, a Team Exchange can be used, where players can add themselves to a roster of members who wish to join teams. A team may then invite a member on the Team Exchange to join their team. If the member accepts, the member is added to the team and the team's profile is updated accordingly.

Once created, the team can then play the real estate game (step 307). In one embodiment, guesses are rotated and distributed through the team members. In another embodiment, the team members decide among themselves how the guesses will be submitted. Other means of submitting guesses as a team can also be used.

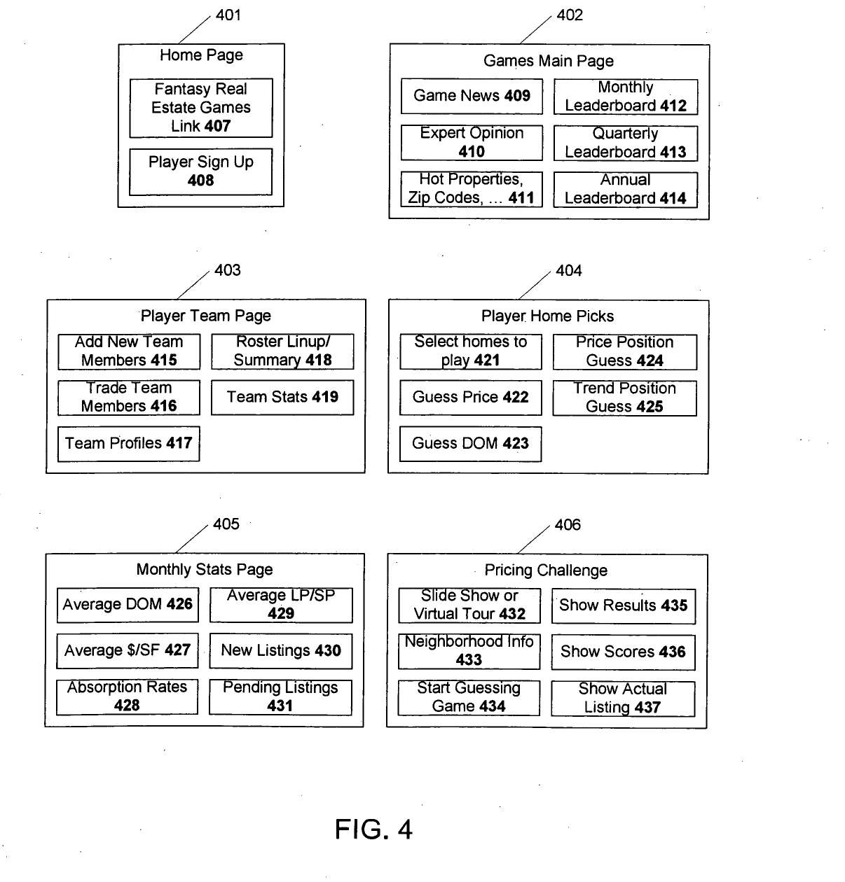

FIG. 4 illustrates contents of sample web pages for the online interactive real estate game. A player first accesses a home page 401 for the game. The home page 401 can include a fantasy real estate games link 407 as well as a player sign up link 408. If a player is new, the player can register by selecting the player sign up link 408. The player can then create a profile and set preferences. Once registered, the player enters the game by selecting the fantasy real estate games link 407. The games main page 402 is then displayed. The games main page 402 can include links for games news 409, expert opinions 410 on properties, and/or information 411 on hot properties, hot zip codes, hot cities, hot neighborhoods, etc. The games main page 402 can also include monthly 412, quarterly 413, and/or annual 414 leaderboards.

If a player chooses to create or modify a team, then the player team page 403 is displayed. The player team page 403 can include links to add new team members 415, trade team members 416, create/edit team profiles 417, view roster lineup or summary 418, and/or view team statistics 419.

Once the game begins, the player home picks page 404 is displayed. The player home picks page 404 can include links for the player to select homes available to play 421, guess the price of a home 422, guess the days on the market (DOM) 423, make a price position guess 424, and/or to make a trend position guess 425.

The player's guesses are collected, from which statistical reports can be generated. These reports can be viewed through the monthly stats page 405. The monthly stats page 405 can include links to an average DOM report 426, an average price per square foot report 427, an absorption rates report 428, an average listing price/selling price report 429, a new listings report 430, and/or a pending listings report 431.

If a player chooses price to be the variable for the real estate game, then a pricing challenge page 406 is displayed. The pricing challenge page 406 can include links to show a slide show or virtual tour 432, to show neighborhood information 433, to start the guessing game 434, to show the results 435, to show the scores 436, and/or to show the actual listing 437.

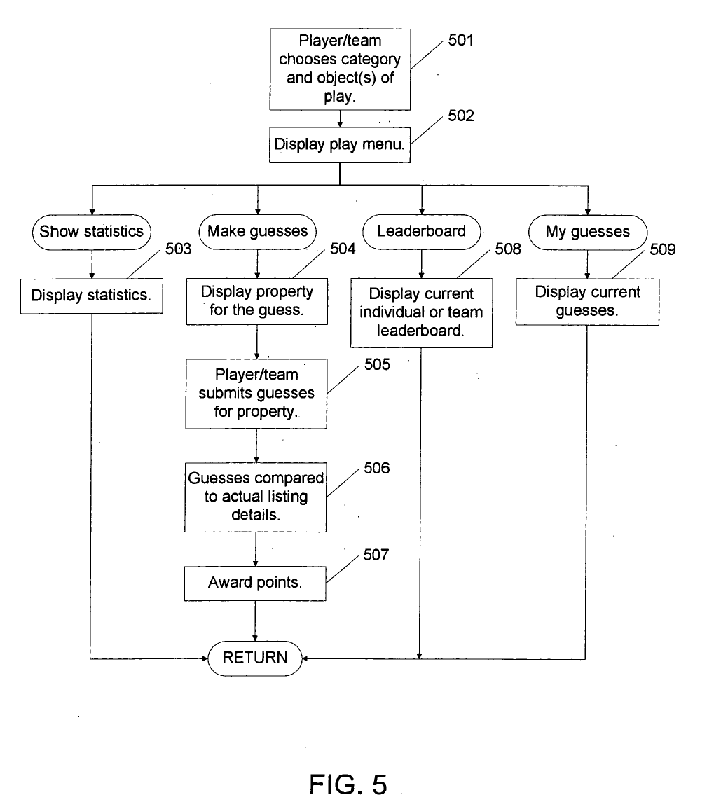

FIG. 5 is a flowchart illustrating in more detail the playing of the real estate game. To start the game, the player or team is asked to choose a category and one or more objects of play (step 501). A category can include a property, a neighborhood, an area, a city or zip code, etc. An object of play can include prices, days on market, appreciation/depreciation trends, features of a property, neighborhood characteristics, etc. For example, a player/team can choose a zip code and to guess the listing price for that zip code. Next, the play menu is displayed (step 502). In one embodiment, the play menu includes links to show statistics, make guesses, show the leaderboard, and show my guesses. If the show statistics link is selected, then statistics for the category/object are displayed (step 503) for the purpose of making guessing easier. If the leaderboard link is selected, then the current individual or team leaderboard is displayed (step 508). If the my guesses link is selected, then the current guesses are displayed (step 509).

If the make guesses link is selected, then a property for the guess is displayed (step 504). The player/team submits guesses for the object(s) for the property (step 505). These guesses are compared to the actual listing details for the property, and the results are displayed (step 506). Points are then awarded (step 507) based on the performance and/or activities of the player. For example, if the object is price, then it is determined how close the price guess is to the actual listing price for the property. If the price guess is within 5%, then 500 points are awarded. If the price guess is within 10%, then 400 points are awarded. If the price guess is within 15%, then 300 points are awarded, etc. The appropriate leaderboards can then be updated.

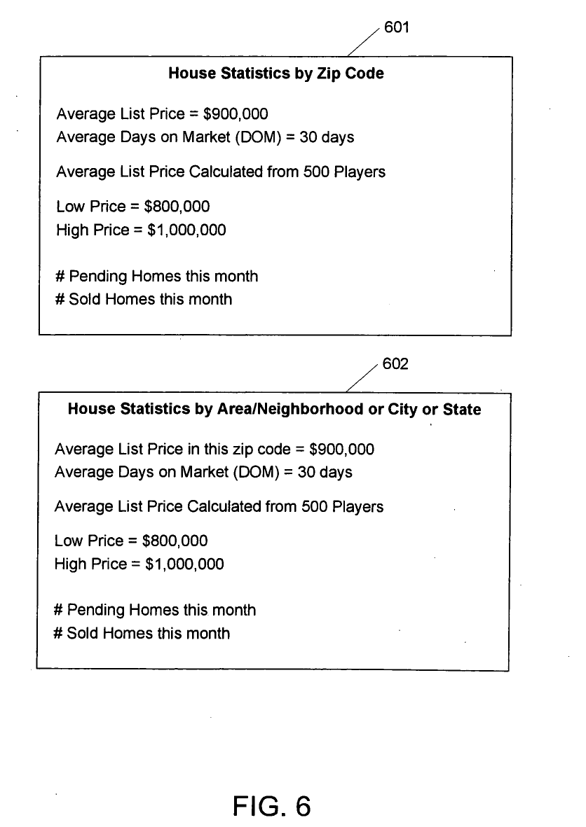

FIG. 6 illustrates sample statistical reports that can be generated from the guesses collected through the online interactive real estate game. The first sample report 601 is a house statistics report by zip code. The statistics in the first report 601 can include an average list price from the guesses, an average DOM from the guesses, and the number of players from which the average list price is calculated. The report 601 can further include the low and high price guesses, as well as the number of pending and sold homes this month. The second sample report 602 is a house statistics report by area, neighborhood, city, or state. The statistics in the second report 602 can include an average list price in this zip code from the guesses, an average DOM from the guesses, and the number of players from which the average list price is calculated. The report 602 can also include the low and high price guesses, as well as the number of pending and sold homes this month. These statistics can be downloaded and/or displayed and shared with other websites through RSS feeds or any other syndication technologies.

Before the game begins, the player/team chooses the game they wish to play (See step 204 in FIG. 2). Two types of games include a pricing challenge and an experts challenge. These games are described in further detail below.

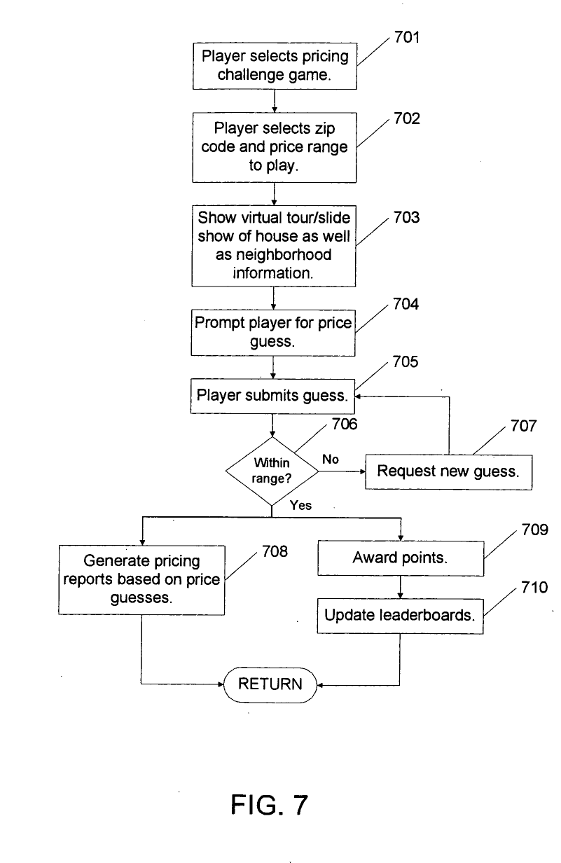

FIG. 7 is a flowchart illustrating an embodiment of the pricing challenge. First, the player selects the pricing challenge game (step 701). The player selects a zip code and a price range to play (step 702). Listings with the properties for sale that meet the zip code and price range criteria are then displayed. The player is next shown a virtual tour or slide show of a listed house, as well as information about its neighborhood (step 703). The slide show or video tour cycles through pictures of the house to familiarize the player with the property. The neighborhood information may include recent sale prices, local school API scores, etc.

Next, the player is prompted for a price guess (step 704), and the player submits a guess (step 705). The guess price is compared with the actual listing price (step 706). If the guess price is outside of a certain predetermined range, then the player is prompted for a new guess (step 707). Optionally, if the price guess is higher than the list price, the player can be prompted for a lower price. If the price guess is lower than the list price, then the player can be prompted for a higher price.

Points are awarded (step 709) based on the player's performance and activities. For example, different points can be awarded based on the number of guesses required before the player is within the predetermined range. Optionally, the amount of time the player takes to make the guess can be captured. Different points can then be awarded based on how long it took the player to guess a price within the predetermined range. After points are awarded, the leaderboards are updated (step 710).

In addition to awarding points, the player's guesses are collected and used to generate pricing reports (step 708). The results can then be shown and/or distributed to owners, sellers, real estate agents, investors and others.

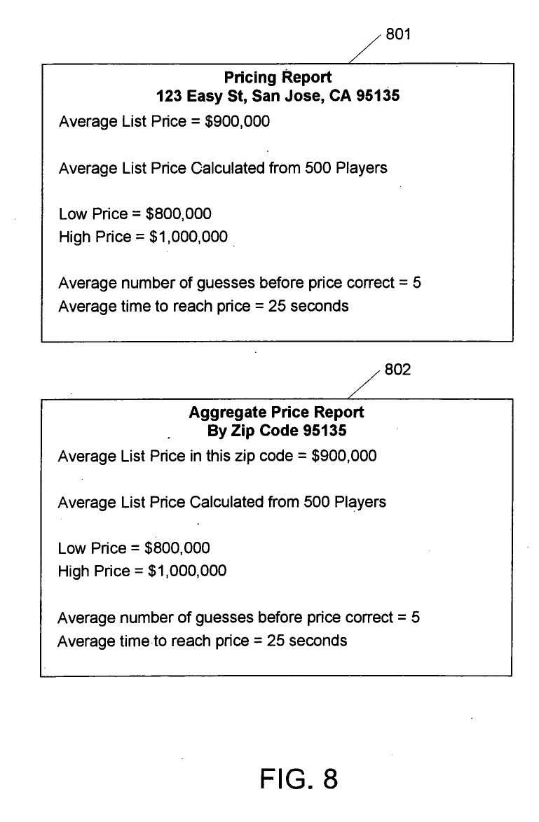

FIG. 8 illustrates example pricing reports. Pricing report 801 by property includes an average list price for the property calculated from players' guesses, the number of players from which the average list price is calculated, and the low and high price guesses. Optionally, the report 801 can include an average number of guesses before the guess price is within the predetermined range and an average time for a player to reach a guess price within the predetermined range.

Pricing report 802 is an example aggregate price report by zip code. The report 802 includes an average list price in this zip code from players' guesses, the number of players from which the average list price in this zip code is calculated, and the low and high price guesses. Optionally, the report 802 can include an average number of guesses before the guess price is within the predetermined range and an average time for a player to reach a guess price within the predetermined range.

Steps 702 through 710 in FIG. 7 can be repeated for other properties listed.

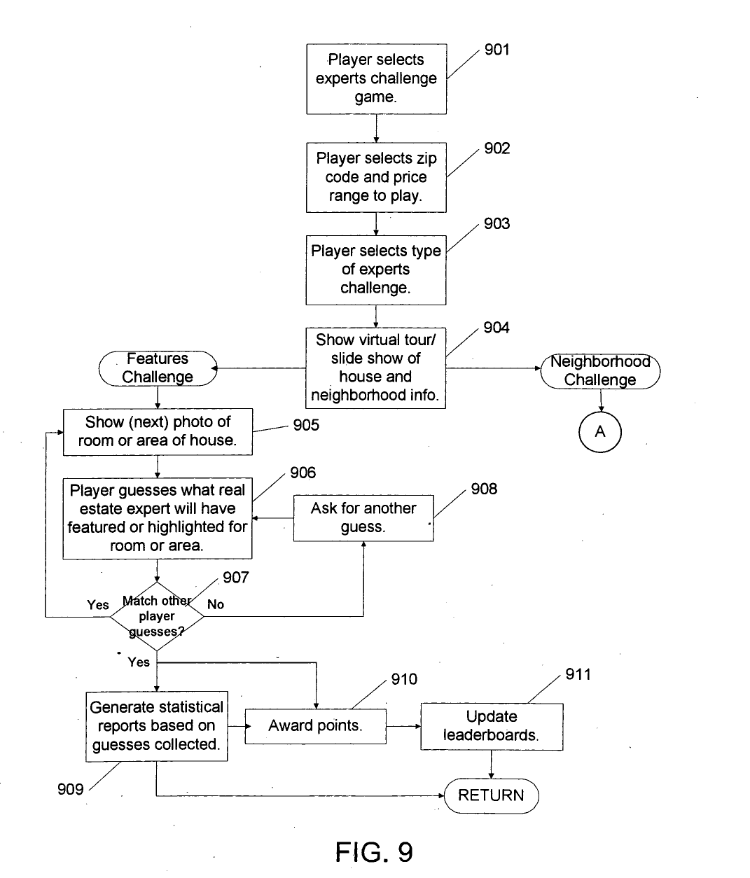

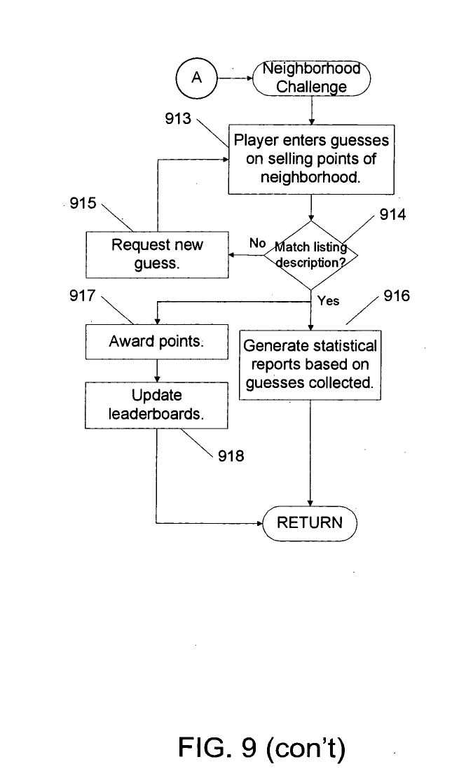

FIG. 9 is a flowchart illustrating an embodiment of the experts challenge. First, the player selects the experts challenge game (step 901). This game can be played individually against the computer or it can be played with multiple players. The game can also be played by comparing the guesses to the actual listing description. The player selects the zip code and price range to play (step 902). Listings with the properties for sale that meet the zip code and price range criteria are then displayed. The player next selects the type of experts challenge to play (step 903). In this embodiment, a features challenge game and a neighborhood challenge game are available. The objective of the features challenge is to guess the highlighted feature or selling point of each room or area of a house in the fastest time. The player's guesses from this features challenge will provide data on what the players think are the best selling features of the home. The objective of the neighborhood challenge is to guess the highlighted amenities or selling points of a certain neighborhood.

In both the features and neighborhood challenges, the player is shown a virtual tour or slide show of a listed house (step 904) to familiarize the player with the house.

If the player selects the features challenge, then the game continues by showing the first photo of a room or area of the house (step 905). The player then guesses the selling point of the room or area (kitchen or lot size) shown in the picture(step 906). If playing a multiple player game, then the player's guess is compared to other player's guesses to see if there are any matches. If playing a single player game, the guess is compared to the listing description. Or if playing a single player game, the guess can be compared to a previously recorded guess from another game session. If the answer does not match any other player guesses (step 907), then the player is prompted for another guess (step 908). Once the player's guess matches another player's (or computer's guess for single player game) the next picture is shown. The game continues until the photos for that particular home are completely cycled through. The player is then awarded points (step 910) according to performance and activity and the leaderboards are updated (step 911).

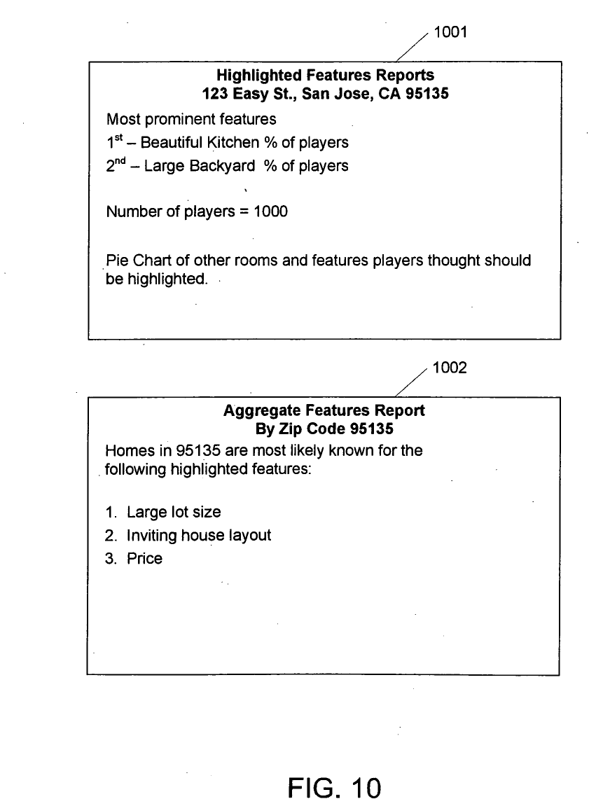

The player's guesses are collected and used to generate statistical reports (step 909). FIG. 10 illustrates sample features reports. The first feature report 1001 is a highlighted features report by property showing the selling points of each picture. The report 1001 can include a list of the most prominent features according to a certain percentage of players, along with the number of players from which this is determined. The report 1001 can further include a pie chart or some other graphic of other rooms and features players thought should be highlighted.

The highlighted features report 1001 can be sent to the owner of the listing, the seller, the listing agent, the buying agent, the buyer, and any other persons authorized to receive such reports by the owner. The report 1001 would give owners a better insight as to what are the selling points and features that should be highlighted for example, in their marketing efforts. Multiple features reports can be aggregated to show what features people are most likely to want in a home. For example, the top 10 most liked features can include stainless steel kitchen, granite counters, and bamboo flooring. Multiple features reports can also be aggregated to improve search results for a player. If a player consistently values a kitchen highly, then that player (who can be a potential buyer or seller) would most likely want to see homes with nice kitchens. This analysis of the player's features guesses can be stored as part of the player's profile. When the player later searches for listed houses, houses with nice kitchens can be given greater weight in the search results.

The second feature report 1002 is an aggregate features report by zip code. The report 1002 can include a list of the highlighted features for homes in the specific zip code. The report 1002 can be used to publish statistics about neighborhoods and zip codes regarding most prominent features of each community. These statistics can be subscribed to through Real Simple Syndication (RSS) feeds or any other method of data syndication.

Returning to FIG. 9, if the player selects the neighborhood challenge, the player enters guesses on the selling points of the neighborhood (step 913). For example, the player can be asked for a guess as to the curb appeal of the house or for the average elementary school API score. If the guesses do not match the listing description (step 914), then the player is prompted for a new guess (step 915). Points are awarded to the player (step 917) based on performance and activity, and leaderboards are updated (step 918). The player's guesses are collected to generate qualitative reports (step 916). The reports can be shown to the player and/or distributed to the owner of the house, the seller, or others. The player's guesses can also be stored in the player's profile to improve later searches, in the same manner as described above with the features challenge.

Although the pricing challenge and the expert challenge are illustrated above with a player, the steps in FIGS. 7 and 9 would also apply to play by a team of players.

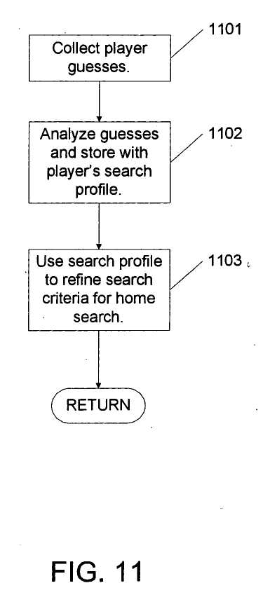

FIG. 11 is a flowchart illustrating the use of a player's guesses in the online interactive real estate game to improve search results. The player's guesses during game play are collected (step 1101). These guesses are then analyzed and stored with the player's search profile (step 1102). The search profile is part of the player's overall game profile. The search profile is then used to refine search criteria for a home search requested by the player (step 1103). Each time the player plays, the search results are better refined.

In addition to improving search results, the collected guesses can be also be used to improve pricing expectations for buyers and sellers, improve marketing for agents and sellers, and provide feedback for agents and sellers.

For example, in the pricing challenge, price guesses from the player are collected and evaluated. The price guesses show the range of prices with which the player is most familiar, considering the player's background and personal real estate experience. For example, the first price guess typically shows the player's educated price guess. This price is an indication of the player's past real estate experience and current perception of value. The first price guess can be used to guide a home buyer to homes that more closely match their perception of value or help guide a home seller to better price their property for sale. The number of price guesses and the time the player requires to guess within a predetermined range indicates whether the player (buyer, seller, agent) is realistic in their price expectations. If a wide price gap is prominent (player makes too many guesses and taking too much time), then either the seller's pricing is too high or the buyer's price expectation is too low. As players play the game, the game statistics will help direct buyers and sellers to more realistic pricing through independent unbiased game play.

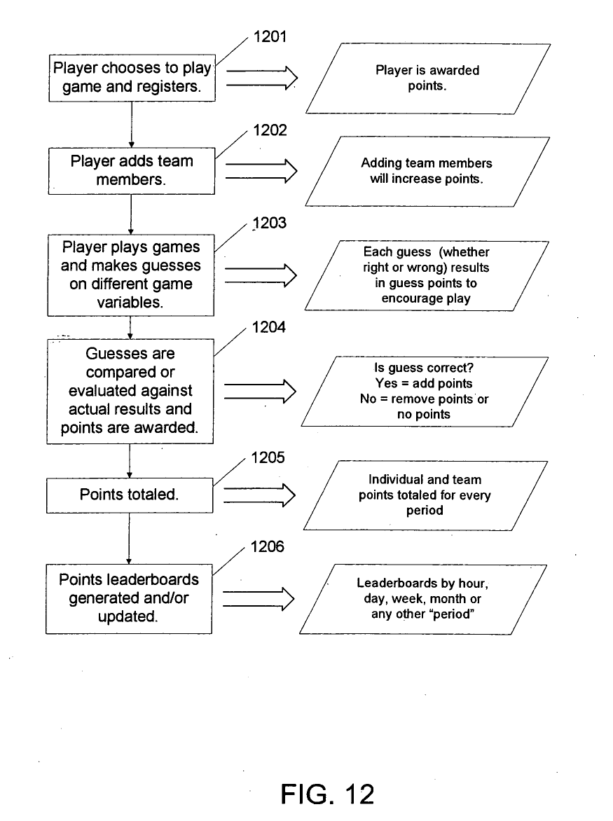

FIG. 12 is a flowchart illustrating an example points system in the online interactive real estate game. When the player chooses to play the game and registers (step 1201), the player can be awarded points. When the player adds team members (step 1202), more points can be awarded. When the player plays the games and makes guesses on different game variables (step 1203), guess points can be awarded for each guess, whether the guess is right or wrong, in order to encourage play. When the player's guesses are compared or evaluated against actual results (step 1204), points can be awarded if the guess is correct. Points can be removed, or no points awarded, if the guess is wrong. The points earned are totaled (step 1205), for individuals and teams for every period. A period can be a span of time (such as an hour, day, week, month, etc.) or a stage of play. Points leaderboards are generated and/or updated with the total points (step 1206) for every period.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

We claim:

1. A method for providing an online interactive real estate game, comprising the steps of
(a) receiving a log in from a player;
(b) receiving a choice of a type of the real estate game;
(c) receiving guesses from the player for real estate variables for the chosen real estate game;
(d) awarding points according to the guesses; and
(e) generating statistics using the guesses.

2. The method of claim 1, wherein the receiving (a) comprises:
(a1) receiving a selection from the player to create a team; and
(a2) providing options to add, delete, update, or trade team members.

3. The method of claim 2, wherein the providing (a2) comprises:
(a2i) providing the add option, wherein the player adds a new team member.

4. The method of claim 2, wherein the providing (a2) comprises:
(a2i) providing the delete function, wherein the player removes a team member.

5. The method of claim 2, wherein the providing (a2) comprises:
(a2i) providing the update option, wherein the player edits team member information.

6. The method of claim 2, wherein the providing (a2) comprises:
(a2i) providing the trade option, wherein the player trades a team member with another team.

7. The method of claim 1, wherein the receiving (c) comprises:
(c1) receiving a selection of a category and at least one object of play;
(c2) displaying the object of play for the guess;
(c3) receiving from the player a guess for the object of play for the category; and
(c4) comparing the guess to an actual listing detail.

8. The method of claim 7, wherein the category comprises at least one of the following: a property, a neighborhood, an area, a city; a neighborhood; or a zip code.

9. The method of claim 7, wherein the object of play comprises at least one of the following: a price; days on market; a trend; a feature; or a neighborhood characteristic.

10. The method of claim 7, wherein the player is a member of a team, wherein the guess is received from the team.

11. The method of claim 1, wherein the awarding (d) further comprises:
(d1) updating at least one leaderboard.

12. The method of claim 1, wherein the receiving (b) comprises:
(b1) receiving a selection of a pricing challenge game;
(b2) receiving a selection of a zip code and a price range to play;
(b3) displaying a virtual tour or slide show of a listed house and information about a neighborhood; and
(b4) prompts the player for a price guess.

13. The method of claim 12, wherein the receiving (c) comprises:
(c1) receiving the price guess from the player; and
(c2) determining if the price guess is within the price range.

14. The method of claim 1, wherein the receiving (b) comprises:
(b1) receiving a selection of an expert challenge game;
(b2) receiving a selection of a zip code and a price range to play;
(b3) receiving a selection of a type of experts challenge; and
(b4) displaying a virtual tour or slide show of a listed house.

15. The method of claim 14, wherein the selected type of experts challenge comprises a features challenge, wherein the receiving (c) comprises:
(c1) displaying a photograph of a room or an area of the listed house;
(c2) receiving from the player a guess for a highlighted feature for the room or area; and
(c3) comparing the received guess with an actual highlight for the room or area.

16. The method of claim 14, wherein the selected type of experts challenge comprises a neighborhood challenge, wherein the receiving (c) comprises:
(c1) receiving from the player guesses for neighborhood parameters for the listed house; and
(c2) comparing the received guesses with actual values for the neighborhood parameters.

17. The method of claim 1, further comprising:
(f) generating a report on the statistics.

18. The method of claim 17, wherein the report comprises a pricing report generated from a collection of price guesses.

19. The method of claim 17, wherein the report comprises a highlighted features report generated from a collection of features guesses.

20. The method of claim 17, further comprising:
(g) distributing the report to a third party.

21. The method of claim 20, wherein the third party comprises an owner of a listed house, a seller, a buyer, or an agent.

22. The method of claim 1, further comprising:
(f) storing the guesses with a profile for the player, wherein the stored guesses are used to refine search criteria for a home search requested by the player.

23. A system, comprising:
a server for hosting an online interactive real estate game; and
a plurality of databases for storing game-related data,
wherein the server receives a log in from a player, receives a choice of a type of the real estate game, receives guesses from the player for real estate variables for the chosen real estate game, awards points according to the guesses, and generates statistics using the guesses.

24. The system of claim 23, wherein the server receives a selection from the player to create a team, wherein options to add, delete, update, or trade team members are provided.

25. The system of claim 23, wherein the server:
receives a selection of a category and at least one object of play;
displays the object of play for the guess;
receives from the player a guess for the object of play for the category; and
compares the guess to an actual listing detail.

26. The system of claim 25, wherein the category comprises at least one of the following: a property, a neighborhood, an area, a city; a neighborhood; or a zip code.

27. The system of claim 25, wherein the object of play comprises at least one of the following: a price; days on market; a trend; a feature; or a neighborhood characteristic.

28. The system of claim 23, wherein the player is a member of a team, wherein the guess is received from the team.

29. The system of claim 23, further comprising at least one leaderboard, wherein the leaderboard is updated after the points are awarded.

30. The system of claim 23, wherein the choice of the type of the real estate game comprises a pricing challenge game, wherein the server:
receives a selection of a zip code and a price range to play;
displays a virtual tour or slide show of a listed house and information about a neighborhood; and
prompts the player for a price guess.

31. The system of claim 30, wherein the server:
receives the price guess from the player; and
determines if the price guess is within the price range.

32. The system of claim 23, wherein the choice of the type of the real estate game comprises an expert challenge game, wherein the server:
receives a selection of a zip code and a price range to play;
receives a selection of a type of experts challenge; and
displays a virtual tour or slide show of a listed house.

33. The system of claim 32, wherein the selected type of experts challenge comprises a features challenge, wherein the server:
displays a photograph of a room or an area of the listed house;
receives from the player a guess for a highlighted feature for the room or area; and
compares the received guess with an actual highlight for the room or area.

34. The system of claim 32, wherein the selected type of experts challenge comprises a neighborhood challenge, wherein the server:
receives from the player guesses for neighborhood parameters for the listed house; and
compares the received guesses with actual values for the neighborhood parameters.

35. The system of claim 23, wherein the server further generates a report on the statistics.

36. The system of claim 35, wherein the report comprises a pricing report generated from a collection of price guesses.

37. The system of claim 35, wherein the report comprises a highlighted features report generated from a collection of feature guesses.

38. The system of claim 35, wherein the server further distributes the report to a third party.

39. The system of claim 38, wherein the third party comprises an owner of a listed house, a seller, a buyer, or an agent.

40. The system of claim 23, further comprising a storage for the guesses with a profile for the player, wherein the stored guesses are used to refine search criteria for a home search requested by the player.
